(19) United States
(12) Patent Application Publication
(10) Pub. No.: US 2016/0243906 A1
(43) Pub. Date: Aug. 25, 2016

(54) TIRE CHAIN LINK

(71) Applicant: QUALITY CHAIN CANADA LTD., Surrey (CA)

(72) Inventor: Wesley Smith, Surrey (CA)

(21) Appl. No.: 14/628,051

(22) Filed: Feb. 20, 2015

(51) Int. Cl. B60C 27/08; B60C 27/06

(52) U.S. Cl. CPC B60C 27/086; B60C 27/068

(57) ABSTRACT

A forged tire chain link comprises two attachment apertures and a plurality of integrally forged, spaced upstanding studs having square cross-sections, preferably oriented at 45 degrees to the longitudinal axis of the link. The inside surfaces of the apertures are flat and the base and top of the link body include beveling to the outside in their central portions. The vertical extent of the ends of the link taper to apices. The link provides enhanced traction for forestry and similar environments.

### FIELD OF THE INVENTION

This invention relates to tire chain links for use with heavy duty vehicles such as for mining and forestry applications.

### BACKGROUND OF THE INVENTION

Tire chain link meshes are formed by attaching links to rings so as to interconnect the links and form a mesh pattern. Typically, the links include attachment apertures through which the rings are threaded. Clearance between the rings and the edges of the apertures allow the links to move about the ring, making the tire chain as a whole flexible and enabling it to be installed on the tire. However the ability of the links to move about the rings of the tire chain can cause friction between adjacent links and accordingly the links can tend to wear unevenly.

The principal functions of tire chains are to provide protection against tread wear and to enhance traction. When used in the abrasive environments of mines, the design of tire chains tends to be optimized for protection against wear. In other applications, such as forestry, traction enhancement is a more important objective.

The design of tire chains usually involves a trade-off between the two functions. In applications where wear protection is more important, relatively small pitch lengths (the span between the distal inner edges of the attachment apertures) such as 63 millimeters or 73 millimeters are used, resulting in relatively tight mesh patterns that maximize tread protection. However short pitch lengths and tight meshes increase the likelihood of trapping debris, snow and ice between the links thereby impeding rather than enhancing traction in forestry and similar environments.

Tire chain links sometimes provide a featureless working surface such as in U.S. Pat. No. 3,892,268 to Asbeck. However it is more common, particularly for traction tire chains, to provide studs on the working surface of the links. U.S. Pat. No. 5,058,645 to Müller provides a single V-shaped profiled element; U.S. Pat. No. 4,357,975 to Baldry provides a plurality of arcuate upstanding plates; and U.S. Pat. No. 6,520,231 to Dohmeler provides a plurality of button studs. Where studded links are provided, partial rotation of the links about the rings allows the studs to be angled sideways, thereby reducing their effectiveness.

Prior art studded tire chain links generally feature welding of the studs to the main body of the link. In a typical tire chain, there may be more than 1500 welds having regard to the welding of the studs onto the bodies of the links, the welding of the rings to secure them to the links and the welds associated with the tag chains used to retain the mesh on the tire. With such a large number of welds, weld failures can become an issue in heavy duty applications.

It is an object of the present invention to provide an enhanced traction chain studded link for use in forestry and similar applications that presents an improvement over one or more of the above limitations by providing an improved, forged link and an improved stud configuration.

These and other objects of the invention will be better understood by reference to the detailed description of the preferred embodiment which follows. Note that the objects referred to above are statements of what motivated the invention rather than promises. Not all of the objects are necessarily met by all embodiments of the invention described below or by the invention defined by each of the claims.

### SUMMARY OF THE INVENTION

In one of its aspects, the invention comprises a forged tire chain link having a plurality of studs integrally forged into its top surface.

In another aspect, the attachment apertures of the link present flat rather than rounded inner edges to maximize the contact surface with the ring. This feature minimizes the tendency of the link to rotate about the ring, thereby minimizing the angling of the studs away from the traction surface.

A plurality of spaced studs having square cross-sections are forged into the top surface of the link. The square cross-sections present straight surfaces that enable for reliable traction. In addition, each stud is angled at 45 degrees in relation to the longitudinal axis of the link. This compensates for the 45 degree angle at which the link itself is presented when bound in a chain link pattern to provide a flat gripping surface in relation to the direction of rotation of the tire. In other words, a straight edge (rather than a corner) of each stud is the first part of each stud to contact the ground and the opposing straight edge of each stud is the last part of each stud to leave the ground.

The vertical dimension of the longitudinal ends of the links include a medial apex to minimize the contact surfaces between adjacent links and to thereby limit wear on the links.

The central portion of the base and top of the link is smoothly beveled to a thin base edge to enhance the gripping of the link into the ground.

A pitch length in the range of 100 mm+/−15 mm along with an open diamond design for the studs provides effective traction, minimizes the build-up of snow and ice between the studs and provides good tread protection.

In another aspect, the invention comprises a tire chain link having an elongated body, two attachment apertures for receiving a linking element, and a plurality of spaced, upstanding studs along the body. The attachment apertures are separated by a bridge extending between a base and a top portion of the body. Each of the studs has a square cross-section and the body and the studs are integrally formed. The body has a longitudinal axis and the studs have straight edges. Each of the straight edges forms an angle of 45 degrees with the longitudinal axis. The inside top and bottom surfaces of each of the attachment apertures are flat. The elongated body has opposed longitudinal ends and the vertical extent of each of the ends tapers to a medial apex. A base and a top of the central portion of the body are smoothly beveled toward the outside of the body. The pitch length of the link is between 85 mm and 115 mm.

In a further aspect, the invention comprises a tire chain link having an elongated body, at least one attachment aperture for receiving a linking element, and a plurality of spaced, upstanding studs aligned along the body. Each of said studs has a square cross-section. Each of the studs may be integrally forged with the body.

In another aspect, the body has a longitudinal axis and the studs have straight edges, each of the straight edges forming an angle of 45 degrees with the longitudinal axis.

In another aspect, the body has two attachment apertures. The inside surface of each of the attachment apertures may be flat.

In yet another aspect, the invention comprises a tire chain link having an elongated body and at least one attachment aperture for receiving a linking element. The inside top and bottom surface of the attachment aperture is flat.

In another aspect, the invention comprises a tire chain link having an elongated body, at least one attachment aperture for receiving a linking element, and a plurality of spaced, upstanding studs aligned along the body. The elongated body has opposed longitudinal ends and the vertical extent of each of the ends tapers to a medial apex.

In another aspect, the base and top of the central portion of the body may be smoothly beveled towards the outside of the body.

In a further aspect, the pitch length of the link may be between 85 mm and 115 mm.

The foregoing was intended as a summary only and of only some of the aspects of the invention. It was not intended to define the limits or requirements of the invention. Other aspects of the invention will be appreciated by reference to the detailed description of the preferred embodiments. Moreover, this summary should be read as though the claims were incorporated herein for completeness.

### BRIEF DESCRIPTION OF THE DRAWINGS

The invention will be described by reference to the detailed description of the preferred embodiment and to the drawings thereof in which:

FIG. 1 is a perspective view of the tire chain link according to one embodiment of the present invention;

FIG. 2 is a side view of the tire chain link of FIG. 1;

FIG. 3 is an end view of the tire chain link of FIG. 1;

FIG. 4 is a top view of the tire chain link of FIG. 1;

FIG. 5 is a perspective view of the tire chain link of FIG. 1 with a ring through one of the apertures of the tire chain link; and

FIG. 6 shows a portion of a tire link mesh over a tire composed of tire chain links and rings of the type illustrated in FIG. 5.

### DETAILED DESCRIPTION OF THE PREFERRED EMBODIMENT

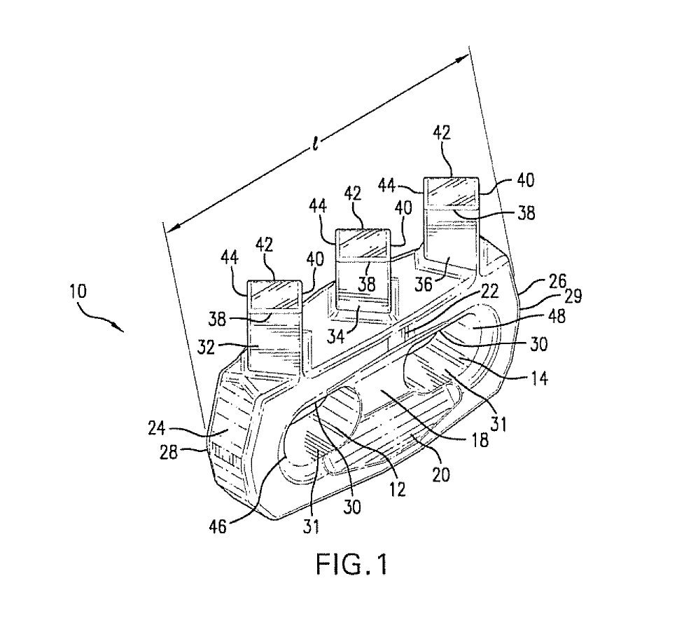

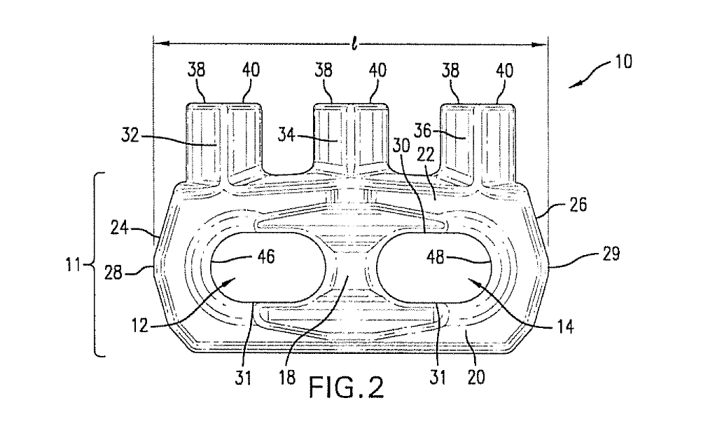

The preferred embodiment of the invention is shown in FIGS. 1 to 6. The tire chain link 10 according to the preferred embodiment is entirely forged as a single piece, including notably the studs 32, 34, 36 located on the top surface of the link.

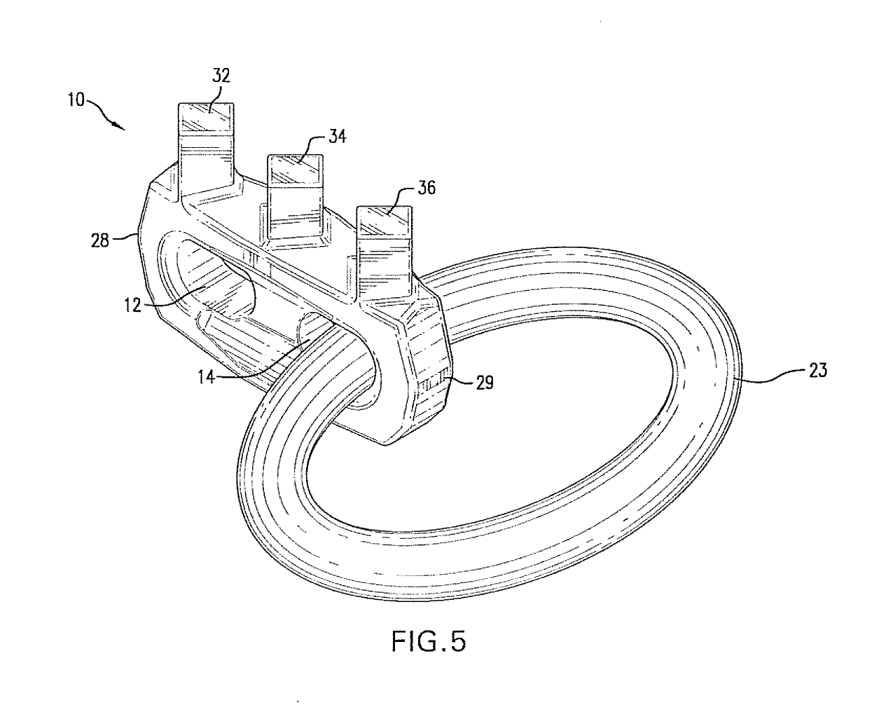

The link 10 has a generally elongated body 11 and comprises two attachment apertures 12, 14 located along the longitudinal extent “l” of the link. The attachment apertures 12, 14 are separated by a bridge 18 connecting the base 20 to the top portion 22 of the link. The attachment apertures 12, 14 are adapted to receive therethrough a ring or other linking element to form the overall tire chain. For example, ring 23 shown in FIG. 5 passes through aperture 14 of the link 10.

It is contemplated that a single attachment aperture without a bridge may also be provided rather than two attachment apertures, although at the expense of a likely loss of resistance to bending along the vertical medial axis depending on the strength of the material used to form the link 10. In a single aperature embodiment the two rings within the link may also come into contact with one another.

The vertical extent of each of the opposed longitudinal ends 24, 26 of the link body tapers to medial apices 28, 29 to minimize the contact surfaces between adjacent links and to thereby limit wear on the links.

As best appreciated by reference to FIG. 1, the top 30 and bottom 31 interior surfaces of the attachment apertures 12, 14 are flat rather than rounded. This feature minimizes the angling of the link about the ring of the tire chain due to a greater portion of the ring being in contact with the flat surfaces 30, 31 compared to rounded surfaces.

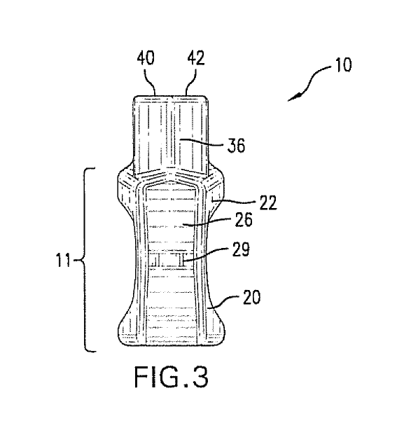

The base 20 and the top 22 of the body are smoothly beveled toward the outer surfaces of the link in the areas below and above the bridge 18 to enhance the traction of the link into the ground. As best seen in FIG. 3, the beveling provide paddle-like edges for gripping the ground.

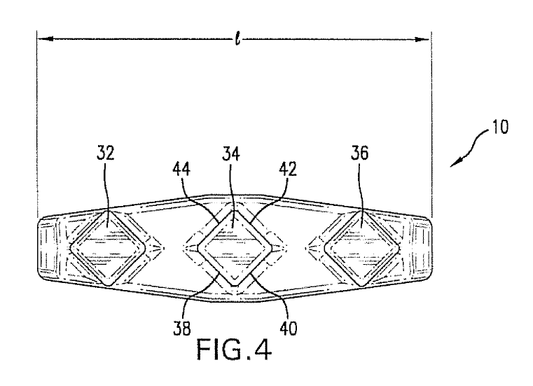

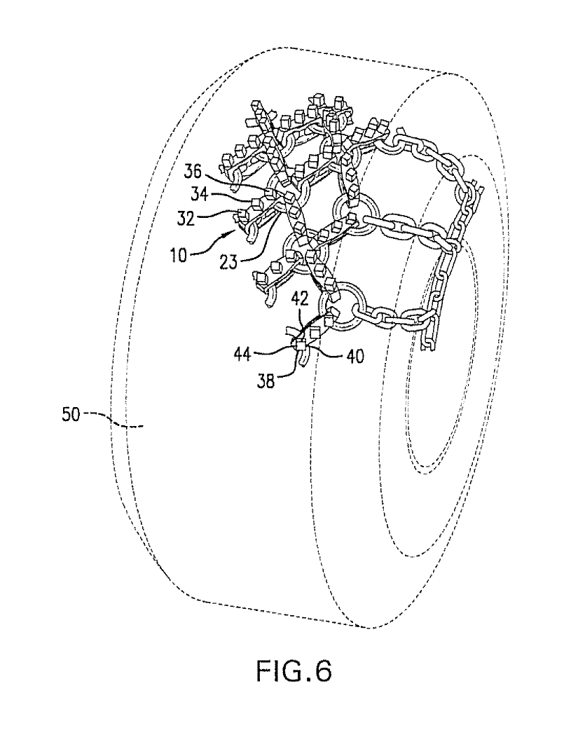

The top portion 22 of the link comprises a plurality of upstanding spaced studs 32, 34, 36 having square cross-sections. The studs 32, 34, 36 are integrally forged with the body. The straight edges 38, 40, 42, 44 of the studs provide an improved traction edge for gripping onto objects. As best appreciated by reference to FIG. 4, the studs are angled such that each edge of the stud forms an angle of about 45 degrees to the longitudinal extent “l” of the link. Referring to FIG. 6, when a tire link mesh is assembled, each tire chain link contains one ring extending through its first aperture and a second ring extending through its second aperture. The links are angled about 45 degrees to the direction of rotation of the tire. Since each edge of the stud is preferably at an angle of about 45 degrees to the longitudinal extent “l” of each link, two opposing stud edges end up being aligned perpendicularly to the direction of travel of the underlying tire thereby enhancing the gripping of the edges onto or into the ground. For example, in FIG. 6, edges 38, 42 are perpendicular to direction of the tire rotation (edges 40, 44 are parallel to the direction of the tire rotation).

While the preferred embodiment illustrated herein shows three studs on each tire chain link, an embodiment using two studs or other numbers of studs is within the scope of the present invention.

The link and the studs may be integrally formed, preferably by forging to avoid the weakness of joints that may be caused by welding.

The pitch length of the link, namely the maximum distance between distal inside edges 46, 48 of the attachment apertures 12, 14 respectively is preferably about 100 mm but may range from 85 mm to 115 mm.

The tire chain link of the preferred embodiment provides a combination of advantages that result in a superior tire chain mesh that exhibits enhanced traction and good tread protection as compared to prior art tire chain links and that is notably suitable for applications in forestry and in other environments involving rough ground that may be combined with snow, ice and organic materials.

It will be appreciated that in the foregoing specification, the invention has been described with reference to specific embodiments thereof. However, the scope of the claims should not be limited by the preferred embodiments set forth in the examples, but should be given the broadest interpretation consistent with the description as a whole. The specification and drawings are, accordingly, to be regarded in an illustrative rather than a restrictive sense.

1. A tire chain link comprising:
an elongated body;
two attachment apertures for receiving a linking element, said attachment apertures being separated by a bridge extending between a base and a top portion of said body;
a plurality of spaced, upstanding studs aligned along said body, each of said studs having a square cross-section and said body and said studs being integrally formed;
said body having a longitudinal axis and said studs comprising straight edges, and wherein each of said straight edges forms an angle of 45 degrees with said longitudinal axis;
the inside top and bottom surfaces of each of said attachment apertures being flat;
said elongated body comprising opposed longitudinal ends and wherein the vertical extent of each of said ends tapers to a medial apex;
a base and a top of the central portion of said body being smoothly beveled toward the outside of said body; and
wherein the pitch length of said link is between 85 mm and 115 mm.

2. A tire chain link comprising an elongated body, at least one attachment aperture for receiving a linking element, a plurality of spaced, upstanding studs aligned along said body, each of said studs having a square cross-section.

3. The tire chain link of claim 1 or claim 2 wherein each of said studs is integrally forged with said body.

4. The tire chain link of claim 2 wherein said body has a longitudinal axis and said studs comprise straight edges, and wherein each of said straight edges forms an angle of 45 degrees with said longitudinal axis.

5. The tire chain link of claim 4 wherein said body comprises two attachment apertures.

6. The tire chain link of claim 5 wherein the inside surface of each of said attachment apertures is flat.

7. A tire chain link comprising an elongated body and at least one attachment aperture for receiving a linking element, the inside top and bottom surface of said attachment aperture being flat.

8. A tire chain link comprising an elongated body, at least one attachment aperture for receiving a linking element, a plurality of spaced, upstanding studs aligned along said body, said elongated body comprising opposed longitudinal ends and wherein the vertical extent of each of said ends tapers to a medial apex.

9. The tire chain link of claim 2 wherein the base and top of the central portion of said body are smoothly beveled toward the outside of said body.

10. The tire chain link of claim 2 or claim 7 wherein the pitch length of said link is between 85 mm and 115 mm.
